(19) United States
(12) Patent Application Publication
(10) Pub. No.: US 2005/0174251 A1
(43) Pub. Date: Aug. 11, 2005

(54) Wall supported fire and smoke alarm having laser light

(76) Inventor: Robert L. Terry III, Houston, TX (US)

Correspondence Address: JAMES L. JACKSON;JAMES L. JACKSON, P.C., 10723 Sugar Hill Drive, Houston, TX, 77042, US

(21) Appl. No.: 11/046,963

(22) Filed: Jan. 31, 2005

Related U.S. Application Data
(60) Provisional application No. 60/541,120, filed on Feb. 2, 2004.

(51) Int. Cl. G08B 7/00

(52) U.S. Cl. 340/691.1; 340/506

(57) ABSTRACT

A fire and smoke alarm device having a device body is removably supported on a wall by a fire resistant support loop and has a battery powered electronic circuit including a sensor for detection of a predetermined level of combustion emissions and emitting a shrill pulsating audible alarm. The device repetitively emits a pre-recorded voice alert in alternating relation with the pulsating audible alarm to alert persons who might not be easily alerted by horn or siren signals. The device incorporates a laser and/or LED light that is energized by the electronic circuitry and project a light beam from an adjustable arm or appendage of the device body. A light diffusing member is located remotely from the device body and is positionable to diffuse the light beam and to guide emergency personnel to the area being monitored.

### RELATED PROVISIONAL APPLICATION

Applicant hereby claims the benefit of U.S. Provisional Patent Application No. 60/541,120, filed on Jan. 31, 2004 by Robert L. Terry, III and entitled “Guardian Angel Fire and Smoke Alarm”.

### BACKGROUND OF THE INVENTION

1. Field of the Invention

The present invention relates generally to fire and smoke alarm systems for detecting the presence of smoke and/or heat and rendering an alarm to alert those present in the area and to signal the need for evacuation to an area of safety. More specifically, the present invention concerns a smoke and fire alarm device that is intended to be supported on a wall of a room by a fire resistant support device that renders the device portable so that it can be transported from place to place for use as desired. More specifically, the present invention concerns a fire and smoke alarm system in the form of a doll, animal or toy having an arm-like appendage supporting a laser device and/or an LED light that is energized by the electronic circuitry of the fire and smoke alarm and which is manually positionable and lockable for selective orientation of a laser beam or LED light to guide emergency personnel to a room or area where a person or child may be located. Even further, the present invention concerns a fire and smoke alarm system having a prism or other light beam diffusing feature to clearly and immediately identify a window, door or other opening to emergency personnel to guide them to specific locations in a building for immediate assistance of adults and children who might be present and in danger. The electronics of the fire and smoke alarm feature provides a shrill audible signal and a pre-recorded voice message that alternate with one another to provide emergency assistance.

2. Description of the Prior Art

Fire and smoke detection and alarm systems have been in wide use for many years. Typically, a fire and smoke detection and alarm system for a residential dwellings, and in many cases commercial establishments such as hotels, restaurants, schools and the like, takes the form of a small, battery powered self-contained unit that is typically fixed to a ceiling or wall of a room and thus is permanently mounted. To provide for smoke and fire detection in other rooms, additional units are typically strategically installed. Typical smoke detection and alarm units incorporate a battery powered electronic circuit including a detector or sensor for smoke and other emissions of combustion and a horn or siren for emitting a loud piercing audible signal to alert the occupants of the need to evacuate the premises.

### SUMMARY OF THE INVENTION

It is a principal feature of the present invention to provide a novel portable fire and smoke alarm device having a selectively positionable appendage supporting a laser and/or LED device which is energized by the electronic circuitry of a fire and smoke alarm and having a light diffusion system that provides for selective illumination of windows, doors and other structures to identify to emergency personnel the likely areas where the emergency personnel may discover children or other persons who might be present and might be incapacitated.

It is also a feature of the present invention to provide a novel portable fire and smoke alarm device that incorporates a fire resistant hanger enabling the device to be removably supported by a wall of a room;

It is another feature of the present invention to provide a novel portable fire and smoke alarm device that has an adjustable and lockable appendage providing support for a laser and/or a LED that is adjustably oriented by manual manipulation of the position of the appendage;

It is also a feature of the present invention to provide a novel portable fire and smoke alarm device that has a decorative and pleasing form for use in children's rooms and for transportation and use to other areas and other locations as suites the needs and desires of the user; and

It is an even further feature of the present invention to provide a novel portable fire and smoke alarm device that provides audible siren or horn signals and audible voice alert and signals to more efficiently enable sleeping persons, especially children, to awaken and become oriented sufficiently to safely exit a smoke filled room and to provide an efficient guide for emergency personnel so that persons in danger may be quickly located and moved to a place of safety.

Briefly, the various objects and features of the present invention are realized through the provision of a portable fire and smoke alarm device that is intended to be hung from a picture hanger, nail or other wall support such that it is position a short distance below the ceiling of the room. When the device is energized response to sensing combustion emissions, the electronic circuitry of the device energizes a laser and/or a LED to orient and guide those in the room toward safety and to guide emergency personnel to the area being monitored. The laser and/or LED is supported by an adjustable arm or appendage that is manually positioned and locked to ensure that the arm or appendage remains at its set position until the position is manually changed. The beam of the laser is caused to strike a light diffusion element to develop a laser pattern to identify the location of persons who might need assistance in the event of fire or smoke.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate onlya typical embodiment of this invention and are therefore not to be considered limiting of its scope, for the invention may admit to other equally effective embodiments.

In the Drawings:

FIG. 1 is a pictorial representation showing a bedroom of a child and showing a fire and smoke alarm system constructed according to the principles of the present invention and removably supported from a wall of the room and having the form of a stuffed bear animal with an arm of the bear having a laser and shown projecting a laser beam to a doorway of the room;

FIG. 2 is a front elevational view showing the fire and smoke alarm system of FIG. 1 in greater detail;

FIG. 3 is a side elevational view of the fire and smoke alarm system of FIGS. 1 and 2, showing a support element being mounted to the rear of the stuffed bear for support of the device by a picture hanger or any other wall mounted support;

FIG. 4 is a block diagram type electronic circuit for the fire and smoke alarm system of FIGS. 1-3;

FIG. 5 is another pictorial representation illustrating the bed room of a child and showing a light diffusing prism of the present invention being mounted to a window so that the diffused light can be seen from externally of the building and serve as a guide for emergency personnel to the area being monitored by the fire and smoke alarm;

FIG. 6 is a partial elevational illustration of the fire and smoke alarm device of FIGS. 1-5 with a part thereof broken away and shown in section and showing a laser and/or LED positioning mechanism thereof in detail;

FIG. 7 is a partial sectional view of a fire and smoke alarm device embodying the principles of the present invention and showing a mechanism for positioning and locking an arm or appendage thereof for maintaining the position of a laser beam being generated by the laser thereof when electronically energized responsive to the presence of combustion emissions; and

FIG. 8 is a partial sectional view taken through the fire and smoke alarm device of FIG. 1, showing the fire and smoke alarm unit being mounted within the body structure of the device.

### DETAILED DESCRIPTION OF PREFERRED EMBODIMENT

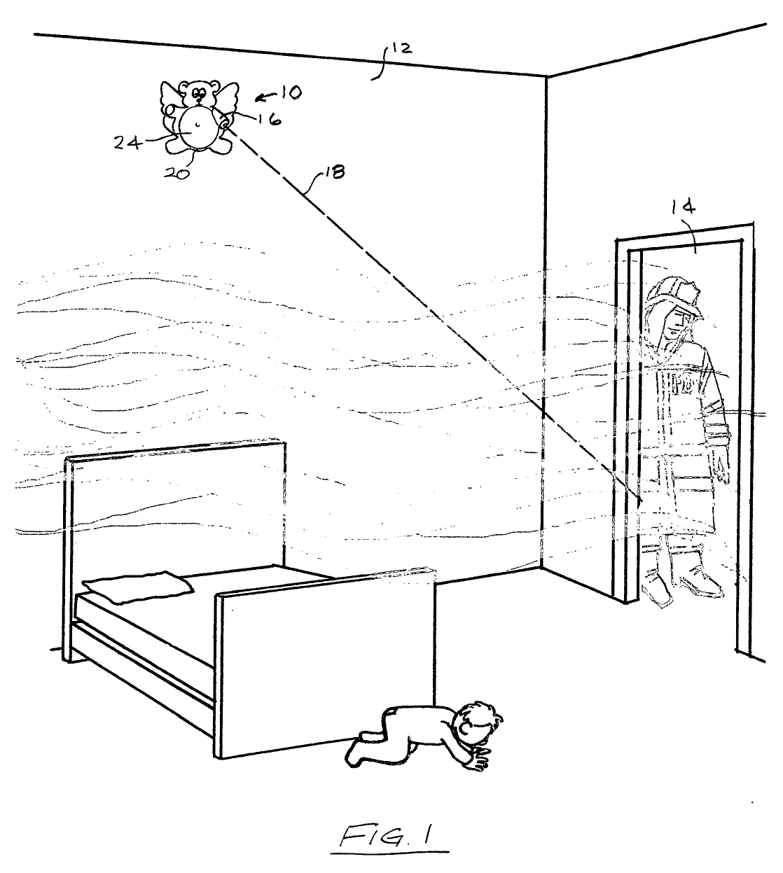

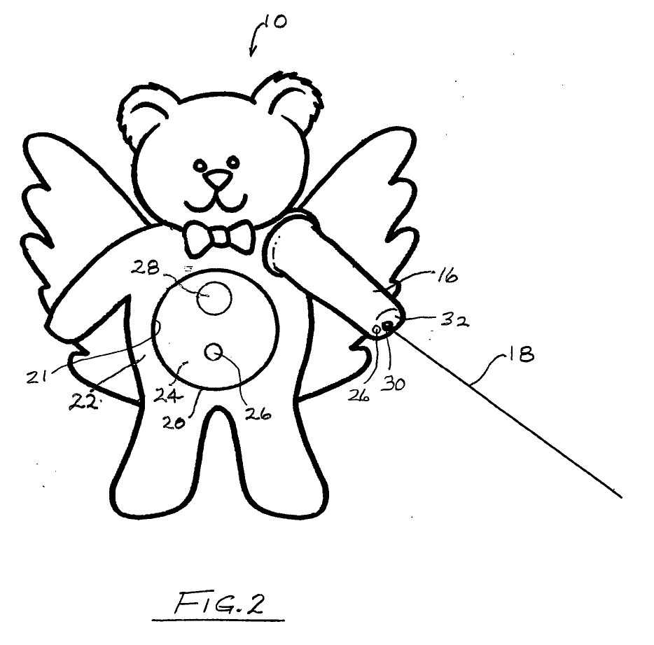

Referring now to the drawings and first to FIG. 1, the pictorial illustration shows a fire and smoke alarm device, generally at 10, being supported by the upper portion of a wall 12 of a room having a doorway 14 defining part of a path for use by emergency personnel in locating the area being monitored so that it may be searched as early as possible for quick location of persons, such as children, who may need emergency assistance. The fire and smoke alarm device 10 is shown to have an arm or appendage 16 which may be oriented to point in any desired direction and to be locked or otherwise retained at a selected position. A laser device or an LED or both are supported at the end of the adjustable arm or appendage and the laser device projects a laser beam 18 to a specific location such as the doorway 14 as shown in detail in FIG. 2. When a LED is employed, the LED does not emit a concentrated light beam as is the case with a laser, but rather emits light to illuminate a portion of the room or area and, more importantly, to serve as a location beacon to which emergency personnel will be guided for location of a room or area that, especially at night time, is frequently occupied by a child or an adult that may lack sufficient mobility to facilitate evacuation in a direction toward safety.

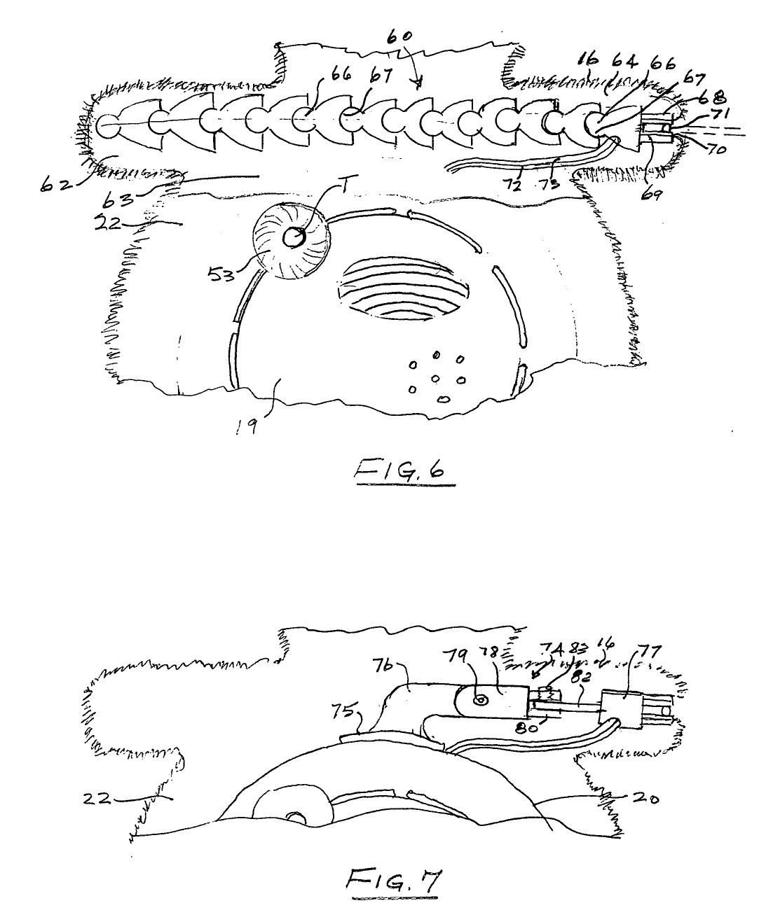

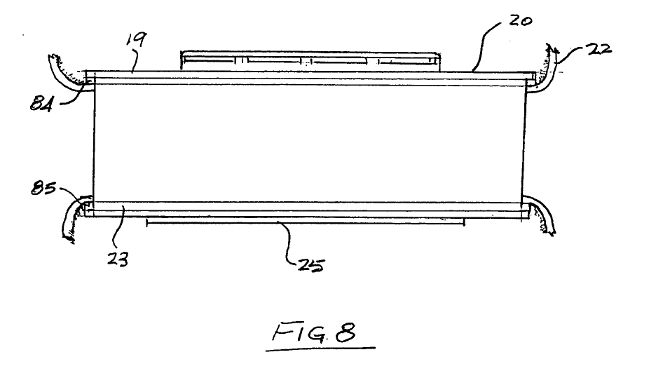

With reference to FIG. 2, the fire and smoke alarm device 10 is shown in the form of a stuffed animal bear, but such is not intended to limit the spirit and scope of the present invention, it being within the scope of this invention to employ any suitable device, such as a toy, doll, decorative plaque etc. for support of a fire and smoke alarm unit 20. The fire and smoke alarm device 10 has a manually positionable pointing arm 16 for support and orientation of a laser device or LED light or both to project a light beam to a desired location and to illuminate a portion of a room or area. The manually positionable pointing arm 16 is capable of being selectively oriented and positioned to selectively direct the light beam being emitted. The manually positionable pointing arm 16 is also capable of being locked at pre-set positions, as discussed below in connection with FIGS. 6 and 7, so that the direction of the laser beam and/or LED light emitted from the point arm 16 does not tend to change. Thus, the drawings hereof are provided only for the purpose of illustrating possible embodiments of the present invention, it being within the spirit and scope of the present invention to employ other embodiments as well.

The fire and smoke alarm unit 24 is shown to be mounted within an opening 21 in a front body portion 22 of the fire and smoke alarm device 10 and can have any suitable form, such a having a generally circular housing 24 as shown. A rear portion 23 of the fire and smoke alarm unit 20 includes a removable cover plate 25 that is exposed at the rear portion of the body portion of the fire and smoke alarm device 10. The cover plate 25 may be removed such as for periodic replacement of the battery as needed. The fire and smoke alarm unit 20 has a typically red test button and LED 26 that functions as an indicator light to confirm that the device is operable and that its battery has sufficient electrical charge for sensing combustion emissions and rendering an audible alarm and illuminating the laser and/or LED area illumination light sources. The test button and LED 26 functions during testing of the fire and smoke alarm unit 20 to provide an indication of its operative or inoperative state, depending on the condition of charge of its battery.

The fire and smoke alarm device 10 may be in the decorative form of a doll, bear or other animal, a toy and having a non-flammable, fire resistant hanger to enable the device to be supported on a wall within a building structure. The fire and smoke alarm device may have a number of acceptable forms but for use in children's rooms is preferably in the form of a decorative doll or animal-like toy. The fire and smoke alarm device is provided with an appendage or arm that is manually positionable for selective orientation and provides support for a laser and/or LED device that is energized for illumination by the battery powered electronic circuitry of the fire and smoke alarm device. When the fire and smoke alarm device 10 is in the form of a bear or doll, the adjustable arm or appendage will be provided by the arm of the bear or doll.

A self-contained, battery powered fire and smoke alarm unit having a fire and smoke responsive electronic circuit is fixed to the device and is normally oriented so that its combustion emissions sensor or sensors are positioned for efficient detection of a condition of fire or/and smoke. The fire and smoke alarm device 10 has an arm or appendage 16 that provides support for a laser device 30 and may also support a LED device 27 that is mounted to the arm or appendage 16 so as to be simultaneously positioned when the laser is selectively oriented. The Laser is energized by the electronic circuitry of the fire and smoke alarm unit 20 responsive to sensing a predetermined level of combustion products within the area being monitored. When energized the laser device 30 projects a laser beam in a selected direction that is determined by the position of the adjustable arm or appendage and provides in smoke an indication of a direction to safety that can be followed by those present in the room. Also the laser beam provides a beacon for emergency personnel leading them toward the source of the laser beam to assist in locating children or adults that might be present in the room.

It is important that the fire and smoke alarm device serve the function of identifying for emergency service personnel the most likely areas within a building where occupants, such as children, may be located at specific times. For example, in night time conditions the fire and smoke alarm device, when energized is enabled by a laser and/or LED light system and a prism or other light diffusion system to diffuse narrow beams of light to illuminate windows or other specific structures to guide emergency personnel and ensure that any persons within designated areas are quickly located and moved to a place of safety. A light diffusing member such as a multifaceted prism is intended to be mounted such that it is in the path of the laser beam. When struck by the laser beam the prism causes diffusion of the laser beam and defines a multiplicity of laser beams that are visible to emergency personnel and help locate the entrance into a room or area being monitored by the fire and smoke alarm system. In the event a LED is mounted to the adjustable arm or appendage of the fire and smoke alarm device, it will be illuminated simultaneously with the laser and will illuminate at least a portion of the room or area and further serve to identify a path to safety and identify to emergency personnel the location of the room or area being monitored.

The housing 24 of the fire and smoke alarm unit 20 also provides an audible signal opening 28 from which an electronic alarm signal or a signal from a horn of siren is projected into the room being serviced by the unit. The audible alarm signals are in the form of a loud pulsating alarm from a horn or siren being controllably operated by electronic circuitry of the smoke alarm unit. Also, the fire and smoke alarm system of the present invention is adapted to emit voice alert and instruction signals in the form of a short prerecorded message, such as “wake up” for example, which is programmed into a computer memory chip from an audible signal generator or speaker that is operated by the electronic circuitry of the fire and smoke alarm unit.

The bending or locking pointing arm or appendage 16 is capable ofbeing manipulated in any suitable manner so that, from the position of the fire and smoke alarm device on a wall of a room, a laser and/or LED device 30 that is mounted within the arm is selectively oriented to project its laser beam 18 to a specific location that can be visualized by a person within the room or can be followed by emergency personnel to guide them into the room for inspection. The terminal end portion 32 of the pointing arm 16 defines an opening through which the laser light is emitted from the laser and/or LED device 30. Alternatively, the laser and/or LED devise may be mounted to the arm or appendage in any suitable fashion so that the arm 16 can be manually moved to project or orient the light beam as desired. The pointing arm or appendage 16 is also capable of being locked in the manually oriented position so that desired orientation of the laser and laser beam is maintained until such time as further adjustment is accomplished to accommodate different laser beam orientation, such as to accommodate re-positioning of the fire and smoke alarm. This feature enables the portable unit to be easily and efficiently moved to another location in a building or to be transported to another building, such as for use of the fire and smoke alarm device 10 in a hotel for example. The device 10 is simply removably mounted on a wall and the arm or appendage is then easily manually positioned to guide emergency personnel to and into a monitored area where assistance may be needed by persons in the monitored area. The arm or appendage 16 can then be locked or stabilized at the adjusted position.

It is desirable therefore to provide a portable fire and smoke alarm device that can be efficiently supported in a room from a picture hanger or nail by a fire resistant loop or hanger thus enabling the device to be simply and efficiently removed from the wall structure and transported to another desired location. This feature ensures that the fire and smoke alarm device is sufficiently portable that it can be transported in automobiles or in the luggage of air passengers and used in hotels or offices. It is also desirable to provide a portable fire and smoke alarm device having an adjustable and lockable appendage providing for support and selective orientation of a laser and/or LED that is energized by smoke or heat responsive activation of a battery powered electronic fire and smoke alarm circuit. The adjustable and lockable appendage permits a user to quickly install a picture hanger or nail and simply hang the device in properly elevated position within a room and quickly orient and lock the arm or appendage to point the laser beam in the proper direction. The laser beam diffusing capability of a prism type light diffusion member will provide emergency personnel with easily recognizable indication, in the form of diffused laser beams. These light diffusion beams are easily recognized by emergency personnel and identify specific areas of a building structure where incapacitated occupants are likely to be, thus enabling emergency personnel to quickly locate and move to safety any persons who might be unable to exit from the monitored area.

As is evident from FIG. 3, a fire resistant hanging loop or member 34 is mounted to the rear body or head portion 36 of the fire and smoke alarm device 10 by a mounting member 30. The fire resistant hanging loop or member 34 may be in the form of a simple wire loop or a loop composed of metal chain, polymer coated wire, etc. It is important that in the event of fire or excessive heat the support loop will not give way and permit the device 10 to fall from its position on the wall. If desired the hanging loop or member 34 may take the form of a simple hanging strap having a hole at its free end to receive the hook portion of a picture hanger 40. The hanging loop or strap is preferably of a length that locates the opening of the loop or strap at or slightly above the top of the head portion of the decorative or toy-like fire and smoke alarm device 10. This feature permits one to see the hook of the picture and the opening of the hanger loop or strap so that the device is easily placed on a picture hanger hook or a nail and hung from the wall. Preferably, the hanger loop or strap defines a large opening that is easily positioned on a supporting member such as a picture hanger hook or nail that projects from the wall 12.

Also, since fire and smoke alarm devices are important for the protection of children, it is desirable to provide fire and smoke alarm devices in decorative and pleasing form for location in children's rooms and to provide audible alert signal devices, such as horns or sirens that are energized sequentially or alternatively with a prerecorded voice alert or very basic audible instructions to alert occupants, especially children, and help them proceed to a place of safety or help guide emergency personnel to their location in the event of fire or smoke detection.

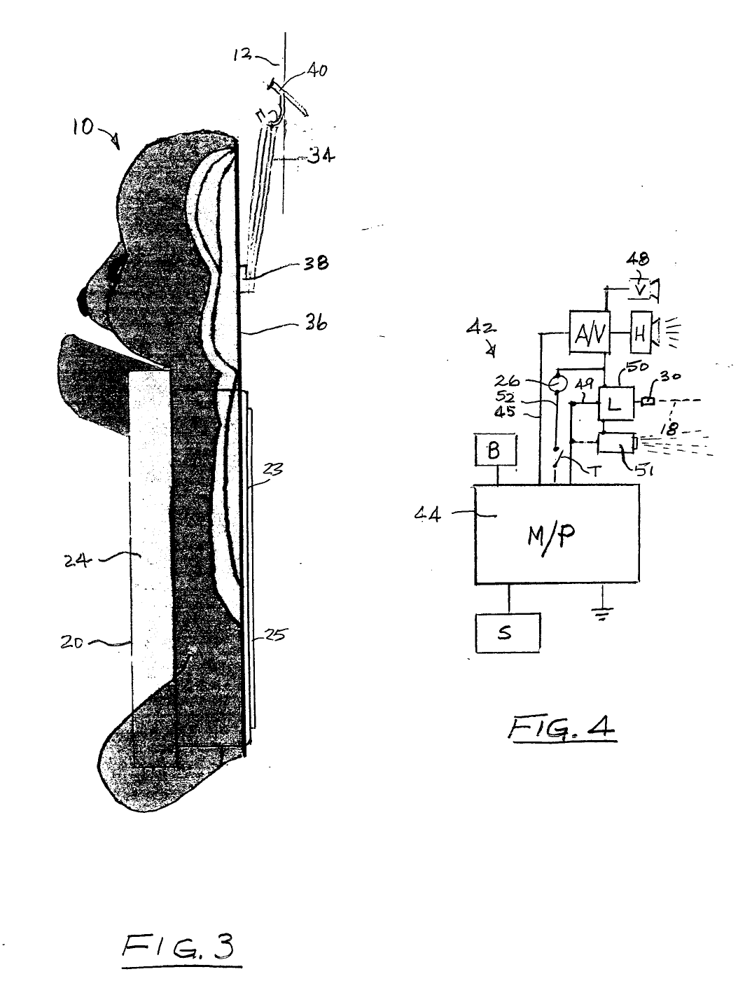

Referring now to FIG. 4, a block diagram electronic circuit for the fire and smoke alarm device of FIGS. 1-3 is illustrated generally at 42. The electronic circuit 42 incorporates an electronic signal receiving, processing and control circuit 44 in the form of a microprocessor M/P having a battery circuit B for DC electrical power supply providing for operation of the fire and smoke detector and alarm. A combustion emissions sensor S is coupled with the microprocessor M/P and functions to continuously sense the environmental atmosphere of the room or area and to provide a circuit energization signal upon detection of a predetermined quantity of combustion emissions in the atmosphere. The sensor S may be of any one of a number of acceptable and commercially available types without departing from the spirit and scope of the present invention. An audio alarm and voice transmission circuit is powered by the battery and controlled by the microprocessor. Upon circuit energization responsive to signals from the sensor circuit S an alarm circuit 47 is energized and thus energizes an audio sound and voice circuit A/V to become energized. The audio sound and voice circuit A/W has a prerecorded voice control V causing a simple voice message such as “Wake Up” to be emitted by a speaker 48. The audio sound and voice circuit A/V provides a timing sequence to cause pulsating and alternating voice signals and horn or siren signals to be sequentially broadcast. The pulsating and alternating voice signals and horn or siren signals are intended to awaken persons, especially children, from deep sleep and to ensure that they take immediate action to leave a smoke filled area and proceed to a place of safety. With recommended training in the use of the fire and smoke alarm system of the present invention, it is quite likely that users of the system will quickly understand the need to evacuate the room and/or residence and move to a designated place of safety.

As mentioned above, though alarm sounds and recorded voice transmissions will awaken and provide direction for many users, it is also desirable to provide visual directional signals responsive to fire and smoke alarm activation to assist those in the area being monitored in understanding the direction to safety and to provide emergency personnel with guidance to the area being monitored. This feature ensures that emergency personnel are enabled to more rapidly search highly critical areas first, so that children and incapacitated persons can be discovered quickly and moved to a place of safety. Accordingly, the electronic circuitry of the present invention, as shown in FIG. 4 is provided with a light circuit 49 that is also energized via the microprocessor circuit 44. A laser circuit L is also coupled with the microprocessor M/P and functions responsive to the microprocessor circuit or responsive to activation of the smoke alarm circuit to activate the laser and/or LED device 26/30 and project a light beam 18 that serves as a beacon to guide emergency personnel to the area that is monitored by the fire and smoke alarm device. The laser circuit 50 is coupled with the light circuit 49 and provides for energization of the laser device 30 which is coupled thereto. The electronic circuitry of the unit is provided with a memory chip having a prerecorded message to assist in alerting those present within the area serviced by the fire and smoke alarm and to assist them in location of specifically monitored areas, especially areas where children may be located. The audio sound and voice circuit portion A/V of the electronic circuitry of the fire and smoke alarm device causes sequential or alternating energization of the prerecorded message with a horn or siren to assist in alerting and providing very basic alert instructions to those present in the monitored area.

A LED circuit 51 is also coupled with the light circuit 49 and may be energized simultaneously with the laser to provide differing light capability for guiding users from a smoke filled area to a place of safety and to guide emergency personnel to the area being monitored. It should be borne in mind that the LED source may not be used; hence its electrical connection is shown in broken line.

It is considered prudent to periodically test the fire and smoke alarm unit to ensure that it will perform properly in the event of a fire or smoke emergency. As further shown in FIG. 4 a test circuit 52 is coupled for power and control via the microprocessor 44 and includes a test switch T. The test switch “T” permits selective testing of the fire and smoke alarm unit 20 to ensure the operational status of the fire and smoke alarm system. The test switch T may be of any suitable character; however preferably the test switch will take the form of a translucent colored test button that is located within an annular depression in the front panel of the fire and smoke alarm unit 20 and is lighted by the status LED as indicated in FIG. 6. Closing of the test switch T by depressing the test button causes illumination of the status LED and/or emission of audible test signals from a horn or siren to confirm that the fire and smoke alarm is operational. The audible test signals, which are controlled by a timing circuit 53 that is incorporated within the test circuit, are in the form of short, intermittent sounds, i.e., several rapid beeps from the horn or siren for a period having a duration of from 1 to 3 seconds. In comparison, when the fire and smoke alarm unit has become energized responsive to detection of combustion emissions, the horn or siren will emit a steady piercing audible signal that will continue until such time as its battery is exhausted or for a time period that is set by a timing circuit that is incorporated as a part of the horn and light activation circuitry. The laser and LED, if a LED is present, are also controlled by the timing circuit.

The test circuit simultaneously tests the operational capability of the light circuits, including specifically the laser light 30 and tests the audio sound and voice circuit A/V. Thus, when testing, pressing the test button switch T will cause short, pulsating beep signals from the horn or siren and will cause energization of the laser 30 during a test period of from 2 to 3 seconds. After expiration of the preset test period the fire and smoke alarm unit will return to its original ready condition.

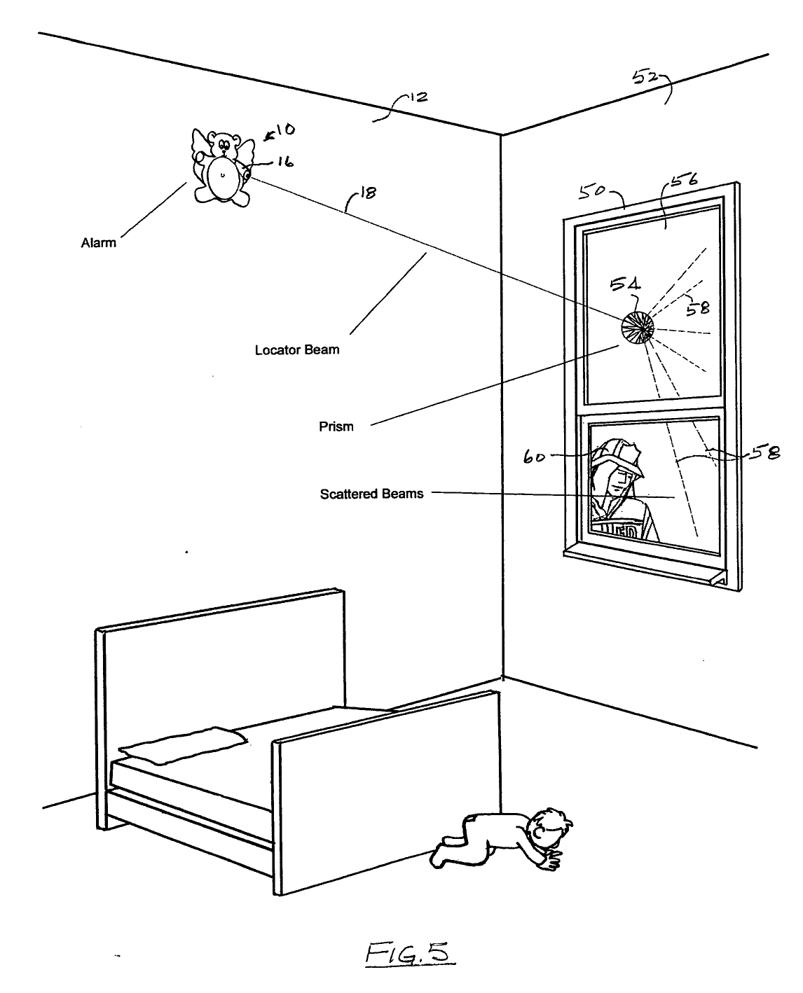

In the event of an emergency condition of fire and/or smoke, it is desirable to ensure that emergency personnel are provided with clear indication of specific critical areas for initial inspection, such as bed rooms, kitchens and the like. Referring now to FIG. 5 a child's bed room is shown by the pictorial illustration, wherein a fire and smoke alarm device 10 is supported at the upper portion of a wall 12. The fire and smoke alarm device 10 is of essentially the same character and construction as discussed above in connection with FIG. 1 and thus like structures and features are referred to by like reference numerals as compared with FIG. 1. A window 50 is shown to be installed in a wall 52 of the room being monitored by the fire and smoke alarm device 10.

A light diffusing element 54, which is preferably in the form of a multifaceted prism, much like a gem-stone having multiple light directing facets, is shown to be mounted to the window glass 56 of the window in position to be struck by the light beam 18. The multiple facets of the light diffusing element or prism cause the light beam to become divided into multiple beans or diffused as shown at 58 so that the diffused light causes development of a light pattern on or radiating from the window glass and identifying a location in the building that should be searched first. The light pattern is visible by an emergency person 60 who are located outside of the area being monitored, thus providing a location or direction signal to guide emergency personnel to a room or area where the presence of a child or adult is likely. The multifaceted prism 54 is positioned in the path of the beam 18 of the laser 30. Light from the laser striking the prism will diffuse the light and serve as a locating light pattern that is seen and recognized by emergency personnel on the outside of the building. The light beam pattern serves to guide emergency personnel to cause them to search that area first and thus potentially minimize the time that is required for clearing the building of all occupants, especially those occupants such a children and invalids who may have no suitable means for escape.

The audible alarm signal is intended to waken sleeping or otherwise inactive persons to ensure that they have time to evacuate from a smoke filled area. In the case of children, however, it is well known that some children are difficult to arouse from sleep, even when a loud and piercing audible alarm signal is occurring. Also, even though children and some adults may be awakened by such an alarm signal, in the dark conditions of night and in the presence of smoke they may become disoriented and confused to the point that they are not able to identify a doorway or other path to safety. Moreover, emergency personnel will typically need to carefully inspect each room of a smoke filled building to ensure that no occupants have been immobilized by smoke inhalation.

When the fire and smoke alarm device 10 has become energized responsive to detection of combustion emissions and the window has become illuminated by the diffused light, the emergency personnel will become immediately aware of a room or area of the building that has a high priority that therefore should be searched first. The diffused laser light, serves a guiding function to ensure searching early on by emergency personnel, thus enhancing the probability of quickly responding to the security needs of a person who might be present within the room.

It is desirable, when the adjustable pointing arm or appendage 16 has been positioned for desired orientation of the laser beam, to secure the pointing arm or appendage at the selected position so that it will not tend to inadvertently move to a position of disorientation. One suitable arm positioning and locking system is shown in FIG. 6 generally at 60. In this case an elongate segmented arm positioning member 61 is located within the soft body structure 22 and has one end thereof received within an arm receptacle 62. The elongate segmented arm positioning member 61 extends substantially completely across the internal body cavity 63 of the soft body structure 22, above the fire and smoke alarm unit 20 with the opposite end portion thereof being received within the opposite arm receptacle 64 as shown in the partial sectional view of FIG. 6.

Each of the multiple segments 65 of elongate segmented arm positioning member 61 is in the form of a ball and socket segment having a ball member 66 at one end thereof and a spherical socket 67 at the opposite end thereof. The ball members are received in rather tight friction fitting relation with the respective socket 67 of the adjacent ball and socket segment so that the segment are secured in releasable assembly with one another and are capable of articulating movement within limits permitted by the construction of the ball members and the sockets. However, the ball and socket assemblies are friction tight to the extent that selective articulation is accomplished with application of manual force, but frictional resistance of the ball and socket connections tend to maintain the ball and socket assemblies in the selected positions. Preferably the ball and socket segments are each composed of a slightly resilient polymer material, such a polypropylene, so that the ball members may be forced into the respective socket 67 or may be pulled from the respective sockets simply by application of manual pushing or pulling force. Thus, each ball and socket member is capable of articulating adjustment with respect to the adjacent ball and socket member, but this adjustment is resisted by the friction fit of the ball members and spherical sockets.

At the far right end of the elongate segmented arm positioning member 61, the last segment includes a ball member 66 that is received in friction fitting articulatable relation within the spherical socket 67 of the adjacent segment. A light mount 68 is integral with the last segment and defined a mounting pocket 69 within which a light cartridge 70 is secured. The light cartridge may be in the form of a laser cartridge having a laser crystal 71 as shown or the light cartridge may be in the form of a LED. The end of the pointing arm 16, if desired, may be provided with both laser and LED cartridges to provide the beneficial aspects of both. Electrical conductors 72 and 73 establish electrical connection within the light cartridge and extend from the last ball and socket segment into the housing structure of the fire and smoke alarm unit for connection with the electronic circuitry shown in FIG. 4. The outer fabric or cover of the pointing arm 16 defines a light opening from which light is emitted. The fabric or cover is secured to the light mount in such manner that the light opening remains open and cannot become blocked by shifting of the fabric or cover.

Referring now to FIG. 7, an alternative embodiment of the present invention is shown wherein positioning and locking of the adjustable arm 16 is accomplished by a universal type joint shown generally at 74 and locking of the universal joint is achieved by locking screws such as set screws. A mounting member 75 is secured or fixed to the housing structure of the fire and smoke alarm unit 20 by bonding or by mechanical attachment with screws or the like and provides a mounting arm 76 having a portion thereof projecting toward a light mount 77. Pivot openings are defined by an end portion of the mounting arm 76 and an end portion of a connector member 78 and receive a pivot connector 79 through which a set screw or other suitable fastener extends. The pivot connector permits articulation of the connector member about the pivot connector. A second pivot connection, offset 90° with respect to the pivotal movement of the connector member 78, comprises pivot members 80 having pivot connection with a pivot member 82 and being locked by a set screw 83 or other suitable fastener. The pivot member 82 is integral with or connected to the light mount 77. The light mount is similar to the light mount 68 of FIG. 6 and provides support for a light cartridge such as a laser cartridge or LED cartridge.

Referring now to FIG. 8, the fire and smoke alarm unit 20 is mounted within the soft body structure 22 such that the front portion 19 of the housing structure 24 is position at the front portion of the soft body and the rear panel portion 23 and its removable cover plate 25 is positioned at the rear portion of the soft body structure. A pair of annular rim members 84 and 85 are disposed in spaced relation and provide for retention of the soft material of the front and rear portions of the soft body so that the fire and smoke alarm unit is secured within the soft body structure 22.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

1. A method for providing audio and visual alarm and direction indicating signals upon detection of a condition of fire and/or smoke in an area being monitored by a fire and smoke alarm system, comprising:
positioning a fire and smoke alarm apparatus on a structural surface in a room in direct view of a potential fire exit;
aligning a smoke penetrating light beam integral to said apparatus toward said fire exit;
locking said light beam in the direction established in the prior step;
continuously detecting fire emissions in said room;
upon detecting fire emissions in said room, actuating said light beam toward said potential fire exit; and
upon detecting fire emissions in said room, actuating a voice recording to enhance escape potential.

2. The method of claim 1, comprising:
positioning a light diffusion means for contact by said light beam upon energization thereof; and
contacting said optical diffusion means to spread said light beam and define a light pattern notifying emergency personnel of the likely location of potential fire victim.

3. The method of claim 1, wherein said light beam is a laser light beam, said method comprising:
positioning a laser light diffusion means at a location for contact by said laser beam upon energization thereof; and
contacting said optical diffusion means with said laser beam to fragment said laser light beam and define a laser light pattern notifying emergency personnel of the likely location of potential fire victim.

4. The method of claim 1, wherein said light beam is a laser light beam, said method comprising:
positioning a laser light diffusion prism on a window exposed to the exterior of a building and in position for contact by said laser light beam upon energization thereof; and
contacting said laser light diffusion prism with said laser light beam to diffuse said laser light beam and develop a laser pattern on the window notifying emergency personnel of the likely location of potential fire victim.

5. A method for providing audio and visual alarm and direction indicating signals in a building upon detection of a condition of fire and/or smoke in an area being monitored by a fire and smoke alarm system having an adjustably moveable appendage supporting a light source creating a light beam, comprising:
positioning a fire and smoke alarm apparatus on a structural surface in a room in direct view of a selected part of the building;
adjustably orienting a smoke penetrating light beam of said adjustably moveable appendage for causing said smoke penetrating light beam to strike the selected part of the building;
locking said adjustably moveable appendage and maintaining said light beam in the direction established in the prior step;
continuously detecting fire emissions in said room;
positioning a light diffusing member on the selected part of the building and in position for contact thereof by said light beam
upon detecting fire emissions in said room, actuating said light beam toward the selected part of the building and striking said light diffusing member; and
diffusing said light beam with said light diffusing member and developing a light pattern notifying emergency personnel of the likely location of potential fire victim.

6. The method of claim 5, wherein said selected part of the building being a window being exposed to the exterior of a building and in position to be contacted by a light beam, said method comprising:
said positioning step being mounting said light diffusing member so that diffused light therefrom defines a light pattern that is visible through the window and provides a visible light pattern notifying emergency personnel of the likely location of potential fire victim.

7. The method of claim 5, wherein said selected part of the building being a window being exposed to the exterior of a building and in position to be contacted by a light beam, said method comprising:
said positioning step being mounting said light diffusing member on the window and aligned with said light beam so that striking said light diffusing member with said light beam causes diffused light to be projected from said light diffusing member onto the window and defining a light pattern on the window that is visible by emergency personnel externally of the building and notifying the emergency personnel of the likely location of potential fire victim.

8. A fire and smoke alarm device comprising:
a device body having means for releasable support of said device body from a support device on a wall of a building structure;
a fire and smoke detector and alarm being mounted to said device body and having a combustions emissions sensor activating said fire and smoke emissions detector upon sensing a predetermined concentration of combustion emissions;
light emitting means projecting a light beam in a selected direction;
means adjustably supporting said light emitting means and being selectively adjustable for positioning said light emitting means to project a light beam in a selected direction;
means locking said adjustably supporting means at the selected position and maintaining the selected direction of said light beam; and
means energizing said light emitting means responsive to energization of said fire and smoke detector and alarm upon activation thereof by said fire emissions sensor.

9. The fire and smoke alarm device of claim 8, comprising:
said light emitting means being a laser light.

10. The fire and smoke alarm device of claim 8, comprising:
said light emitting means being a LED.

11. The fire and smoke alarm device of claim 8, comprising:
said light emitting means being a laser light and a LED.

12. The fire and smoke alarm device of claim 8, comprising:
said locking means being at least two ball and socket members establishing a ball and socket connection having sufficient frictional resistance to movement as to be manually articulatable to a desired position and to frictionally maintain said desired position.

13. The fire and smoke alarm device of claim 8, comprising:
said locking means being a universal joint connection having angularly offset connection members and permitting selective manual positioning movement for selected orientation of said light emitting means and having at least one locking member being manually manipulatable for locking said universal joint against inadvertent movement.

14. The fire and smoke alarm device of claim 8, comprising:
said means energizing said light emitting means being an electronic circuit having a microprocessor and a storage battery coupled with said microprocessor for DC electrical supply;
a combustion emissions sensor being coupled with said microprocessor for continuous power supply and combustion emissions monitoring and providing an electronic alarm signal upon sensing a predetermined minimum level of combustion emissions in the environment being monitored; and
audio and light circuit means being coupled for control and operation by said microprocessor and being simultaneously energized by said microprocessor and providing alternating pre-recorded voice alert signals and audible alarm signals and also energizing said light source and generating a light beam in a selected direction determined by adjustable positioning of said light emitting means.

15. The fire and smoke alarm device of claim 14, comprising:
test circuit means being electronically coupled for control and operation by said microprocessor and being energized for simultaneously testing said audio and light circuit means and said light emitting means; and
manually actuated normally open switch means being coupled in said test circuit means and being manually closed to active said test circuit means.

16. The fire and smoke alarm device of claim 15, comprising:
a timing circuit being incorporated within said test circuit means and determining a timing sequence for simultaneous testing of said audio and light circuit means and said light emitting means.

17. The fire and smoke alarm device of claim 8, comprising:
light diffusing means being located remotely from said light emitting means and in position to receive a light beam from said light emitting means, said light diffusing means diffusing the light beam and defining a light pattern that is visible to emergency personnel and provides location identification notifying the emergency personnel of the likely location of potential fire victim;

18. A fire and smoke alarm device comprising:
a device body having a mounting element for releasable support of said device body from a support on a wall of a building structure;
a fire and smoke detector and alarm being mounted to said device body and having a combustions emissions sensor activating said fire and smoke emissions detector upon sensing a predetermined concentration of fire emissions;
an adjustable pointing arm extending from said device body and being selectively manually moveable to selected positions and being lockable to maintain any selected position;
a laser device being mounted to said adjustable pointing arm and projecting a light beam in a selected direction determined by selective manual positioning of said arm; and
said laser device being energized by said fire and smoke detector and alarm upon activation thereof by said fire emissions sensor.

19. The fire and smoke alarm device of claim 18, comprising:
a light diffuser element being positioned remotely from said device body and upon being struck by said laser light causing diffusion of said laser light and serving as a beacon to guide emergency personnel to an area being monitored by said fire and smoke alarm device.

20. The fire and smoke alarm device of claim 18, comprising:
said fire and smoke detector and alarm having a speaker emitting audible alert signals responsive to activation of said fire and smoke detector; and
said audible alert signals being a shrill pulsating electronic signal and a prerecorded voice alert and instruction signal.

21. The fire and smoke alarm device of claim 20, comprising:
said shrill pulsating electronic signal and a prerecorded voice alert and instruction signal being alternated repetitively.

22. The fire and smoke alarm device of claim 18, comprising:
said device body having front and rear portions; and
a fire and heat resistant hanger element being fixed to said rear portion of said device body and providing for hanging support of said device body from a support device mounted to the wall of the building structure.

23. The fire and smoke alarm device of claim 18, comprising:
said fire and heat resistant hanger element being a wire loop having a lower portion thereof being connected with said rear portion of said device body.

24. The fire and smoke alarm device of claim 18, comprising:
said device body being in the form of a toy having front and back portions; and
said fire and smoke detector and alarm being fixed to said front portion of said device body.

25. A fire and smoke detector and alarm device comprising:
a device body having adapted for releasable support from a wall of a building structure;
a fire and smoke detector being mounted to said device body and having a battery powered electronic circuit including a fire emissions sensor circuit and activating said battery powered electronic circuit upon sensing a predetermination of predetermined fire emissions;
an adjustable pointing arm extending from said device body and being selectively manually positionable and lockable;
a laser device being mounted to said adjustable pointing arm and projecting a laser beam to a selected location determined by selective manual positioning of said arm, said laser device being energized by said battery powered electronic circuit upon activation of battery powered electronic circuit by said fire emissions sensor circuit; and
a light diffuser element being positioned remotely from said device body and upon being struck by said laser light causing diffusion of said laser light and serving as a beacon to guide emergency personnel to an area being monitored by said fire and smoke alarm device.

26. The fire and smoke detector and alarm device of claim 25, comprising:
said fire and smoke detector and alarm having a speaker emitting audible alert signals responsive to activation of said fire and smoke detector; and
said audible alert signals being a shrill pulsating electronic signal and a prerecorded voice alert and instruction signal.

27. The fire and smoke detector and alarm device of claim 25, comprising:
said shrill pulsating electronic signal and a prerecorded voice alert and instruction signal being alternated repetitively.

28. The fire and smoke detector and alarm device of claim 25, comprising:
said device body and front and rear portions; and
a fire and heat resistant hanger element being fixed to said rear portion of said device body and providing for hanging support of said device body from a support device mounted to the wall of the building structure.

29. The fire and smoke detector and alarm device of claim 28, comprising:
said fire and heat resistant hanger element being a wire loop having a lower portion thereof being connected with said rear portion of said device body.

30. The fire and smoke detector and alarm device of claim 25, comprising:
said device body being in the form of a toy having front and rear portions; and
said fire and smoke detector and alarm being fixed to said front portion of said device body.

31. A fire and smoke detector and alarm device comprising:
a device body having adapted for releasable support from a wall of a building structure;
a fire and smoke detector being mounted to said device body and having a battery powered electronic circuit including a fire emissions sensor circuit and activating said battery powered electronic circuit upon sensing a predetermination of predetermined fire emissions;
an adjustable pointing arm extending from said device body and being selectively manually positionable and lockable;
a laser device being mounted to said adjustable pointing arm and projecting a laser beam to a selected location determined by selective manual positioning of said arm to guide persons of the room to a safe location and to identify the location of persons of the room to safety personnel;
said laser device being energized by said battery powered electronic circuit upon activation of battery powered electronic circuit by said fire emissions sensor circuit
said fire and smoke detector and alarm having a speaker emitting audible alert signals responsive to activation of said fire and smoke detector; and
said audible alert signals being a shrill pulsating electronic signal and a prerecorded voice alert and instruction signal being electronically alternated repetitively.

32. The fire and smoke detector and alarm device of claim 31, comprising:
said device body being in the form of a doll or toy having front and rear portions and having at least one appendage having a pointing end and being manually positionable to a variety of positions as desired;
said laser being mounted to said pointing end and being oriented to project a laser beam to a path to safety upon manual manipulation of said appendage; and
said fire and smoke detector being mounted to said front portion of said device body

33. The fire and smoke detector and alarm device of claim 31, comprising:
a light diffuser element being positioned remotely from said device body and upon being struck by said laser light causing diffusion of said laser light and serving as a beacon to guide emergency personnel to an area being monitored by said fire and smoke alarm device.

34. The fire and smoke detector and alarm device of claim 33, wherein the building structure defines a window located within view of said laser device and having a window glass, said device comprising:
said light diffuser element being positioned to receive a laser beam from said laser light and to diffuse the laser beam and present at the window a diffused laser pattern for recognition by emergency personnel of the likely location of a person in an area being monitored by said fire and smoke detector and alarm device.

35. The fire and smoke detector and alarm device of claim 34, comprising:
said light diffuser element being light transparent and defining a multiplicity of light diverting facets diffusing the laser beam and projecting the diffused laser pattern on the window glass of said window.
